(19) United States
(12) Patent Application Publication
(10) Pub. No.: US 2024/0178697 A1
(43) Pub. Date: May 30, 2024

(54) BATTERY AND POWER STORAGE SYSTEM

(71) Applicant: HONDA MOTOR CO., LTD., Tokyo (JP)

(72) Inventors: Soichi MORII, Saitama (JP); Yasuo YAMADA, Saitama (JP); Yoshio KOJIMA, Saitama (JP); Yasushi OGIHARA, Saitama (JP)

(73) Assignee: HONDA MOTOR CO., LTD., Tokyo (JP)

(21) Appl. No.: 18/523,325

(22) Filed: Nov. 29, 2023

(30) Foreign Application Priority Data
Nov. 30, 2022 (JP) 2022-192132

(51) Int. Cl. H02J 7/34; H02J 7/00

(52) U.S. Cl. CPC H02J 7/34; H02J 7/0031; H02J 7/0063; H02J 7/007; H02J 2207/20

(57) ABSTRACT

A battery includes two storages, a positive node connecting positive terminals of the two storages, a negative node connecting negative terminals of the two storages, a main contactor, a cutoff fuse, a connection circuit connecting the negative terminal of the first storage and the positive terminal of the second storage, a first contactor provided in the connection circuit, a second contactor provided between the positive node and a first connection portion connecting the positive terminal of the second storage and the connection circuit, a third contactor provided between the negative node and a second connection portion connecting the negative terminal of the first storage and the connection circuit, and a controller switching between a first state where the two storages are connected in series and chargeable at a first voltage and a second state where the two storages are connected in parallel and chargeable at a second voltage.

### CROSS-REFERENCE TO RELATED APPLICATIONS

This application is based on and claims priority under 35 USC 119 from Japanese Patent Application No. 2022-192132 filed on Nov. 30, 2022, the entire content of which is incorporated herein by reference.

### TECHNICAL FIELD

The present disclosure relates to a battery and a power storage system.

### BACKGROUND ART

In recent years, researches and developments have been conducted on charging and power supply in a vehicle including a secondary battery which contributes to energy efficiency in order to allow more people to have access to affordable, reliable, sustainable and advanced energy.

In relation to charging and power supply in a vehicle including a secondary battery, there are two types of charging equipment such as charge stations which are compatible with 400 V class and 800 V class, respectively. When a vehicle is compatible with only the 400 V class charging equipment, the vehicle cannot enjoy quick charging performance of the 800 V class charging equipment by the 800 V class charging equipment.

In a case where the vehicle is both compatible with the 400 V class charging equipment and the 800 V class charging equipment, generally, a voltage is boosted to 800 V by a voltage converter when charging by the 400 V class charging equipment, or the voltage is stepped down to 400 V by the voltage converter when charging by the 800 V class charging equipment. However, using such a voltage converter for charging deteriorates efficiency during charging.

In this regard, there is known a vehicle which switches a connection system of a battery module so as to be chargeable by both the 400 V class charging equipment and the 800 V class charging equipment without using any voltage converter for charging (for example, see JP2019-080474A and JP2020-150618A).

In such a vehicle, a main contactor and a sub contactor are disposed at a positive end portion and a negative end portion of the battery, respectively, in order to construct a system that will not cause electric shock even in the event of collision or short circuit. As a result, in the event of collision or short circuit, the main contactor and sub contactor are turned off (opened) to cut off connection between the battery and other electrical equipments, thereby avoiding occurrence of electric shock.

However, fewer contactors are preferable in terms of weight and manufacturing costs.

### SUMMARY OF INVENTION

The present disclosure provides a battery and a power storage system capable of reducing the number of contactors while preventing occurrence of electric shock.

A first aspect of the present disclosure relates to a battery, including:
a first power storage;
a second power storage;
a positive node configured to connect in parallel a positive terminal of the first power storage and a positive terminal of the second power storage;
a negative node configured to connect in parallel a negative terminal of the first power storage and a negative terminal of the second power storage;
one of a main contactor and a control cutoff fuse configured to cut off according to a control signal, the one being provided at a side opposite to the first power storage and the second power storage with respect to the positive node;
an other one of the main contactor and the control cutoff fuse, the other one being provided at a side opposite to the first power storage and the second power storage with respect to the negative node;
a connection circuit configured to connect the negative terminal of the first power storage and the positive terminal of the second power storage;
a first switching contactor provided in the connection circuit;
a second switching contactor provided between the positive node and a first connection portion configured to connect the positive terminal of the second power storage and the connection circuit;
a third switching contactor provided between the negative node and a second connection portion configured to connect the negative terminal of the first power storage and the connection circuit; and
a controller configured to control on and off of the main contactor and the first to third switching contactors,
in which the controller is configured to switch between
   a first voltage state in which the first switching contactor is in an on state, the second switching contactor and the third switching contactor are in an off state, and the first power storage and the second power storage are connected in series and chargeable at a first voltage, and
   a second voltage state in which the first switching contactor is in an off state, the second switching contactor and the third switching contactor are in an on state, and the first power storage and the second power storage are connected in parallel and chargeable at a second voltage.

A second aspect of the present disclosure relates to a power storage system, including:
the battery according to the above first aspect of the disclosure;
a three-phase motor in which coils of three phases are connected at a neutral point, the three-phase motor being driven by electric power supplied from the battery;
an inverter connected on an electric power transmission path between the battery and the three-phase motor; and
a DC power supply circuit connected to a connection portion positioned on an electric power transmission path between the inverter and the battery,
in which the DC power supply circuit has a branch circuit connected to a coil of one phase among the coils of three phases at a positive electrode side of the DC power supply circuit.

According to the present disclosure, the number of contactors can be reduced while preventing occurrence of electric shock.

### BRIEF DESCRIPTION OF DRAWINGS

Exemplary embodiment(s) of the present invention will be described in detail based on the following figures, wherein:

FIG. 1 is a diagram showing a configuration of a power storage system 1 according to an embodiment of the present disclosure;

FIG. 2 is a diagram showing a first voltage state (800 V start-up) of a battery 2;

FIG. 3 is a diagram showing a second voltage state (400 V start-up) of the battery 2:

FIG. 4 is a diagram showing a flow of a current during traveling of a vehicle including the power storage system 1;

FIG. 5 is a diagram showing a flow of a current during first voltage (800 V) charging of the vehicle including the power storage system 1;

FIG. 6 is a diagram showing a flow of a current during second voltage (400 V) charging of the vehicle including the power storage system 1;

FIG. 7 is a diagram showing a control configuration of the battery 2;

FIG. 8 is a diagram showing the control configuration of the battery 2:

FIG. 9 is a diagram showing a configuration of a power storage system 1B according to a first modification;

FIG. 10 is a diagram showing a configuration of a power storage system 1C according to a second modification;

FIG. 11 is a diagram showing a configuration of a power storage system 1D according to a third modification:

FIG. 12 is a diagram showing a configuration of a power storage system 1E according to a fourth modification;

FIG. 13 is a diagram showing a configuration of a power storage system 1F according to a fifth modification;

FIG. 14 is a diagram showing a configuration of a power storage system 1G according to a sixth modification; and

FIG. 15 is a diagram showing a configuration of a power storage system 1H according to a seventh modification.

### DESCRIPTION OF EMBODIMENTS

Hereinafter, an embodiment of the present disclosure will be described with reference to the drawings.

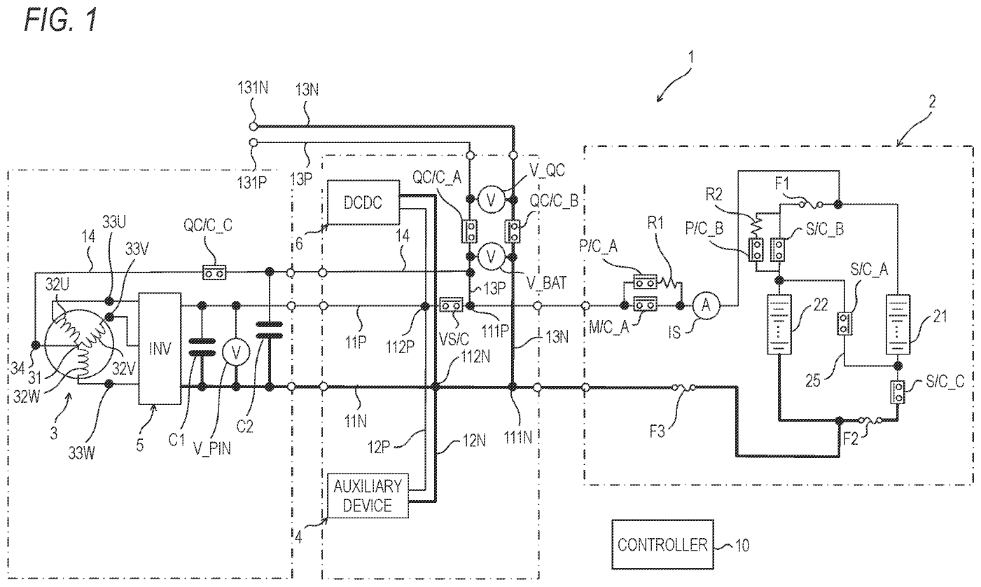

A power storage system 1 shown in FIG. 1 is mounted on a vehicle such as an electric vehicle. The vehicle including the power storage system 1 is compatible with charging equipment of 400 V class and 800 V class. The vehicle can not only quickly charge a battery 2 at charge voltages of 400 V and 800 V but also efficiently drive a three-phase motor 3 and an auxiliary device 4 at a base voltage of 800 V.

Specifically, as shown in FIG. 1, the power storage system 1 includes the battery 2, the three-phase motor 3, the auxiliary device 4, an inverter 5 (PDU), a DC-DC converter 6, electric power supply circuits 11P and 11N, auxiliary device drive circuits 12P and 12N, DC power supply circuits 13P and 13N, a branch circuit 14, and a controller 10. Note that the controller 10 includes a battery ECU that controls the battery 2 and a vehicle ECU that controls the vehicle, and the vehicle ECU controls the battery 2 via the battery ECU.

As shown in FIGS. 1 to 3, the battery 2 includes a first power storage 21, a second power storage 22, first to sixth contactors M/C_A, S/C_A, S/C_B, S/C_C, P/C_A and P/C_B, first and second resistors R1 and R2, a current sensor IS, a first fuse F1, a second fuse F2, and a third fuse F3.

The first power storage 21 and the second power storage 22 are battery modules which can perform charging and discharging of 400 V.

The first contactor M/C_A is provided on a positive end portion of the battery 2 and functions as a main switch which turns on and off connection to the outside (electric power supply circuit 11P) of the battery 2.

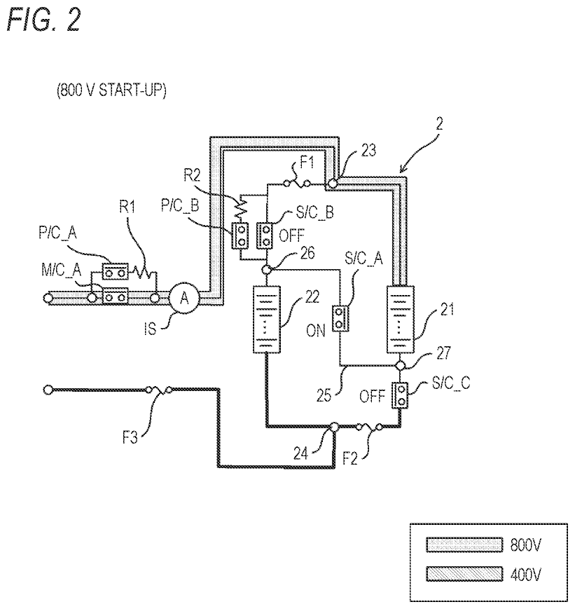

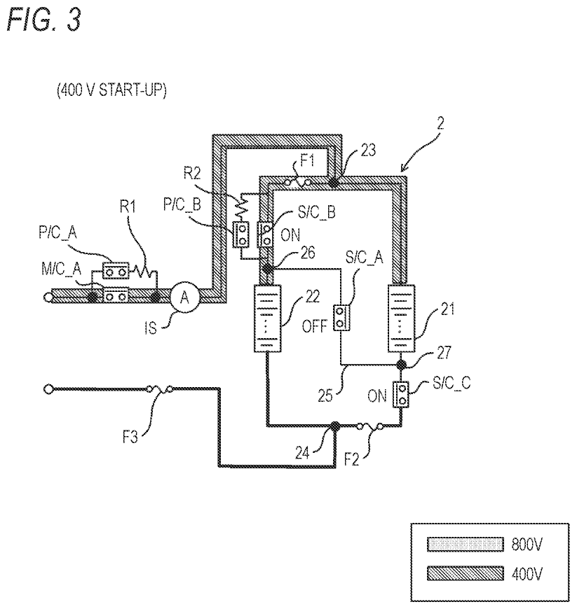

The second to fourth contactors S/C_A, S/C_B, and S/C_C switch a connection state between the first power storage 21 and the second power storage 22. For example, as shown in FIG. 2, when the second contactor S/C_A is turned on whereas the third contactor S/C_B and the fourth contactor S/C_C are turned off, the battery 2 is in a first voltage state (800 V start-up) in which the first power storage 21 and the second power storage 22 are connected in series, so that the battery 2 can perform charging and discharging at 800 V. As shown in FIG. 3, when the second contactor S/C_A is turned off whereas the third contactor S/C_B and the fourth contactor S/C_C are turned on, the battery 2 is in a second voltage state (400 V start-up) in which the first power storage 21 and the second power storage 22 are connected in parallel, so that the battery 2 can perform charging and discharging at 400 V. Note that the term start-up refers to a concept including driving during traveling of an electric vehicle including the power storage system 1 and charging during parking of the electric vehicle.

Specifically, with reference to FIGS. 2 and 3, the battery 2 includes a positive node 23 that connects a positive terminal of the first power storage 21 and a positive terminal of the second power storage 22 in parallel, a negative node 24 that connects a negative terminal of the first power storage 21 and a negative terminal of the second power storage 22 in parallel, and a connection circuit 25 that connects the negative terminal of the first power storage 21 and the positive terminal of the second power storage 22. One end of the connection circuit 25 is connected to a circuit that connects the positive node 23 and the positive terminal of the second power storage 22 at a first connection portion 26, and the other end of the connection circuit 25 is connected to a circuit that connects the negative node 24 and the negative terminal of the first power storage 21 at a second connection portion 27.

The second contactor S/C_A is provided in the connection circuit 25, and the third contactor S/C_B is provided between the first connection portion 26 and the positive node 23, and the fourth contactor S/C_C is provided between the second connection portion 27 and the negative node 24. Therefore, one contactor intervenes in any path from the positive node 23 to the negative node 24.

The fifth contactor P/C_A and the first resistor R1 are arranged in series with each other and in parallel with the first contactor M/C_A. In the first voltage state and the second voltage state, the fifth contactor P/C_A is turned on before the first contactor M/C_A is turned on, thereby protecting the first contactor M/C_A from an excessive inrush current.

The sixth contactor P/C_B and the second resistor R2 are arranged in series with each other and in parallel with the third contactor S/C_B. In the second voltage state, the sixth contactor P/C_B is turned on before the third contactor S/C_B is turned on, thereby protecting the third contactor S/C_B from an excessive inrush current.

The current sensor IS is disposed between the first contactor M/C_A and the positive node 23 to measure a current.

The first fuse F1 is provided between the positive node 23 and the third contactor S/C_B, and the second fuse F2 is provided between the negative node 24 and the fourth contactor S/C_C. Both the first fuse F1 and the second fuse F2 are blown fuses that cut off a circuit by blowing due to an excessive current.

The third fuse F3 is provided on a negative end portion of the battery 2 and cuts off the connection to the outside (electric power supply circuit 11N) of the battery 2 when an abnormality occurs. The third fuse F3 is constituted by a control cutoff fuse that can intentionally cut off a current according to an electrical signal. A control cutoff fuse is, for example, a pyro fuse. That is, when an abnormality such as an impact due to a vehicle collision or a short circuit in the battery 2 occurs, the controller 10 causes the third fuse F3 to perform cutoff and turns off (opens) the first contactor M/C_A. Note that the first fuse F1 and the second fuse F2 may not be control cutoff fuses.

In this way, when an abnormality occurs, the connection with the outside can be cut off at both the positive and negative sides of the battery 2, thereby preventing the occurrence of an electric shock in the event of an abnormality. By using a control cutoff fuse as the third fuse F3, an auxiliary contactor disposed at the negative end portion of the battery 2 is no longer necessary, and the number of parts and a cost can be reduced. Since the contactors S/C_A, S/C_B, and S/C_C are arranged in each path of the battery 2, respectively, if these contactors S/C_A. S/C_B, and S/C_C are also turned off when an abnormality occurs, it is possible to reliably cut off a circuit in either the first voltage state or the second voltage state.

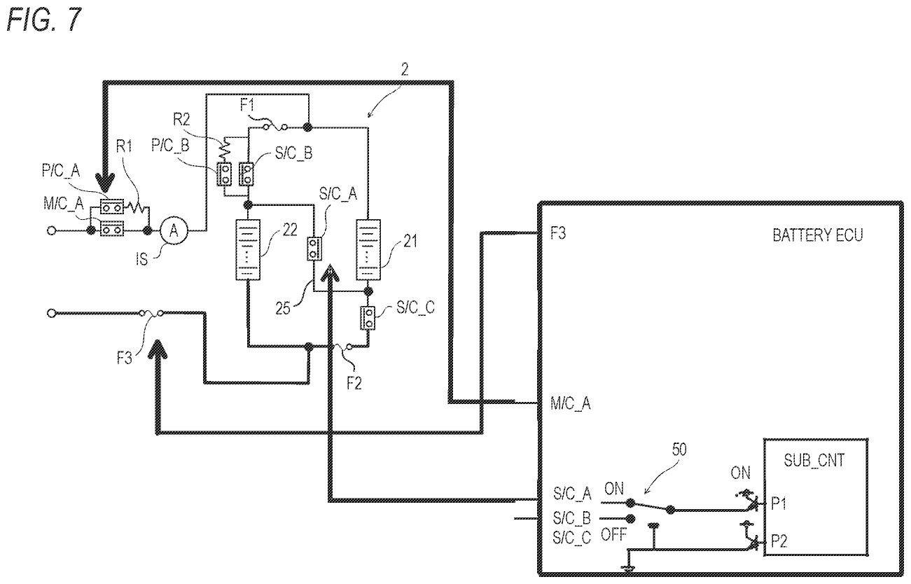

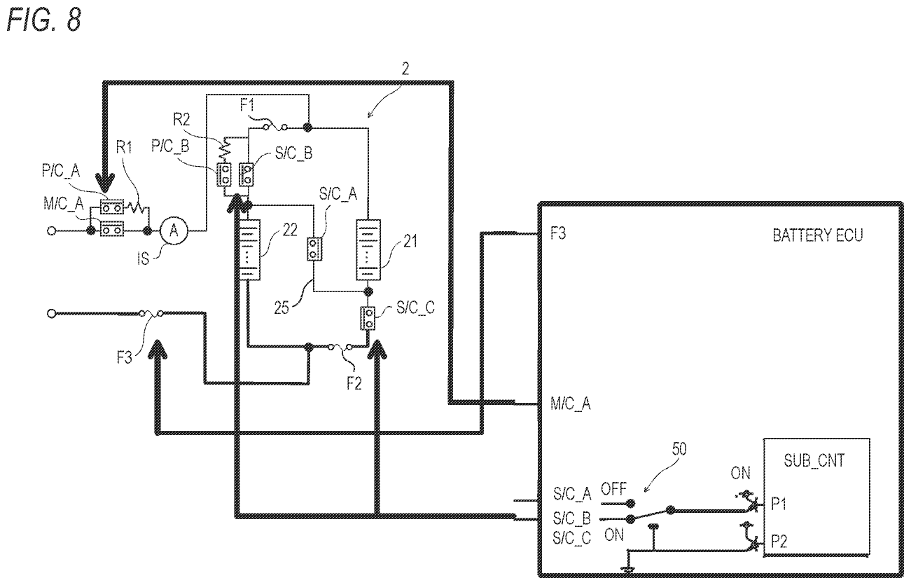

As shown in FIGS. 7 and 8, the controller 10 of the present embodiment includes an auxiliary contactor control unit SUB_CNT, and a selector switch 50 for the contactors S/C_A, S/C_B, and S/C_C is provided downstream of an auxiliary contactor control pin P1 of the auxiliary contactor control unit SUB_CNT. The selector switch 50 is configured to switch between the first voltage state (800 V start-up) in which the second contactor S/C_A shown in FIG. 7 is turned on and the third contactor S/C_B and the fourth contactor S/C_C are turned off, and the second voltage state (400 V start-up) in which the second contactor S/C_A shown in FIG. 8 is turned off and the third contactor S/C_B and the fourth contactor S/C_C are turned on, according to a control signal from a switching pin P2 of the auxiliary contactor control unit SUB_CNT. Therefore, it is possible to prevent the third contactor S/C_B and/or the fourth contactor S/C_C from being turned on while the second contactor S/C_A is in an ON state. Since the selector switch 50 is provided downstream of the auxiliary contactor control pin P1, control signals are output to the contactors S/C_A. S/C_B, and S/C_C on condition that a signal from the auxiliary contactor control pin P1 is an ON signal. The ON signal of the auxiliary contactor control pin P1 can be interlocked with the ON signal of the controller 10 to the first contactor M/C_A, for example. In this way, the contactors S/C_A, S/C_B, and S/C_C can function as auxiliary contactors.

Note that in the present embodiment, although the first contactor M/C_A is provided at a side opposite to the first power storage 21 and the second power storage 22 with respect to the positive node 23, and the third fuse F3 is provided at a side opposite to the first power storage 21 and the second power storage 22 with respect to the negative node 24, the third fuse F3 may be provided at a side opposite to the first power storage 21 and the second power storage 22 with respect to the positive node 23, and the first contactor M/C_A may be provided at a side opposite to the first power storage 21 and the second power storage 22 with respect to the negative node 24.

Returning to FIG. 1, the three-phase motor 3 includes coils 32U, 32V, and 32W of three phases, one end side of each of which is connected to a neutral point 31. The three-phase motor 3 is rotationally driven by electric power supplied from the battery 2 via the inverter 5. The three-phase motor 3 in the present embodiment includes a U-phase terminal 33U, a V-phase terminal 33V, and a W-phase terminal 33W connected to the other end side of each of the coils 32U, 32V, and 32W, respectively, and a neutral point terminal 34 connected to the neutral point 31. The U-phase terminal 33U, the V-phase terminal 33V, and the W-phase terminal 33W are connected to the inverter 5, and the neutral point terminal 34 is connected to the branch circuit 14.

The inverter 5 converts DC electric power supplied from the battery 2 into three-phase AC electric power by switching between a plurality of switching elements, so as to rotationally drive the three-phase motor 3. When a DC (400 V) is supplied from the branch circuit 14 to the neutral point 31 of the three-phase motor 3, the inverter 5 can function as a booster circuit by switching between the plurality of switching elements to boost the DC (to 800 V) using the coils 32U, 32V, and 32W. That is, the coils 32U, 32V, and 32W wound around a stator core are used as transformers.

The auxiliary device 4 is a high-voltage driven in-vehicle device which can be driven by DC electric power from the battery 2 and an external power supply, and examples thereof includes an electric compressor or a heater for air-conditioning. The auxiliary device 4 is connected to the battery 2 via the auxiliary device drive circuits 12P and 12N, a seventh contactor VS/C, and the electric power supply circuits 11P and 11N, which will be described later. The auxiliary device 4 according to the present embodiment is operated at the base voltage of 800 V.

The DC-DC converter 6 steps down DC electric power from the battery 2 and the external power supply to drive a low-voltage driven in-vehicle device. The DC-DC converter 6 is provided with an ammeter (not shown).

The electric power supply circuits 11P and 11N are configured as a positive and negative pair and connect the battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary device drive circuits 12P and 12N (auxiliary device 4) at a side closer to the inverter 5 than the connection portions 111P and 111N. The electric power supply circuit 11P at the positive side is provided with the seventh contactor VS/C which turns on and off the circuit between the connection portion 112P connected to the auxiliary device drive circuit 12P and the connection portion 111P connected to the DC power supply circuit 13P. A first voltage sensor V_PIN and a first smoothing capacitor C1 are provided in the electric power supply circuits 11P and 11N at a side close to the inverter 5, and a second smoothing capacitor C2 is further provided between the electric power supply circuit 11N at the negative side and the branch circuit 14.

The DC power supply circuits 13P and 13N are configured as a positive and negative pair and include one end provided with charge terminals 131P and 131N to which an external power supply such as charging equipment can be connected and the other end connected to the electric power supply circuits 11P and 11N via the connection portions III P and 111N. The DC power supply circuits 13P and 13N are provided with an eighth contactor QC/C_A and a ninth contactor QC/C_B for turning on and off the respective circuits, a second voltage sensor V_BAT at a position closer to the connection portions 111P and 111N than the eighth contactor QC/C_A and the ninth contactor QC/C_B, and a third voltage sensor V_QC at a position closer to the charge terminals 131P and 131N than the eighth contactor QC/C_A and the ninth contactor QC/C_B.

The branch circuit 14 is branched, in the DC power supply circuit 13P at the positive side, at a position closer to the connection portions 111P and 111N than the eighth contactor Q/C_A and the second voltage sensor V_BAT and is connected to the neutral point 31 (neutral point terminal 34) of the three-phase motor 3. An intermediate portion of the branch circuit 14 is provided with a tenth contactor QC/C_C for turning on and off a circuit.

The controller 10 performs on and off control of the first to tenth contactors M/C_A, S/C_A, S/C_B, S/C_C, P/C_A, P/C_B, VS/C, QC/C_A, QC/C_B, and QC/C_C, cutoff control of the third fuse F3, detection of welding of the third fuse F3, and control of the DC-DC converter 6 and the inverter 5.

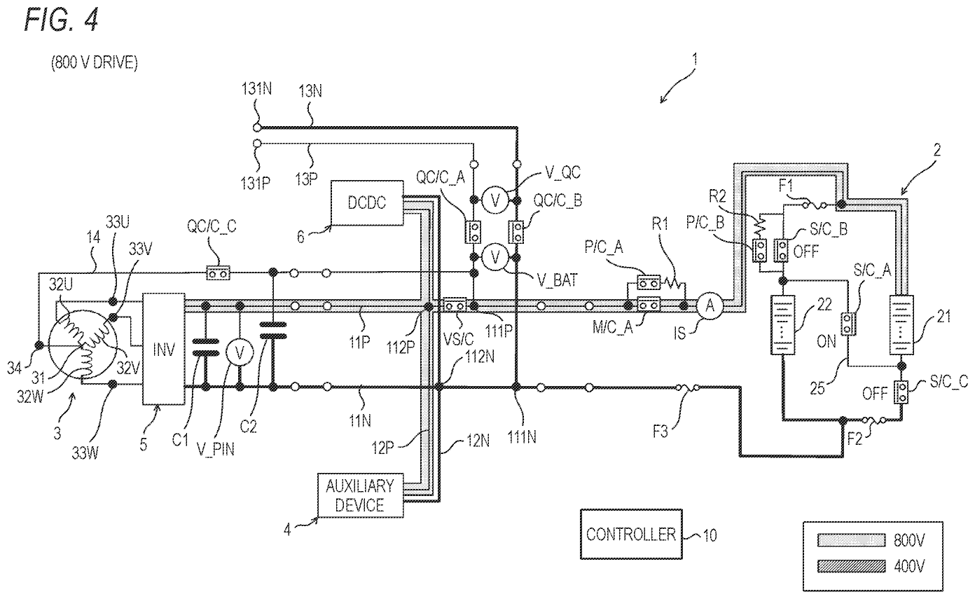

Next, operation of the power storage system 1 will be described with reference to FIGS. 4 to 6.

FIG. 4 is a diagram showing a flow of a current during traveling (800 V drive) of an electric vehicle including the power storage system 1 according to the first embodiment.

During traveling (800 V drive) of the electric vehicle, the controller 10 turns on the second contactor S/C_A, turns off the third contactor S/C_B and the fourth contactor S/C_C, and connects the circuit in the battery 2 to the first voltage state (800 V), and at the same time, turns on the first contactor M/C_A and the seventh contactor VS/C to allow electric power supply from the battery 2 to the inverter 5. In this case, the controller 10 turns off the tenth contactor QC/C_C to cut off the electric power supply from the battery 2 to the three-phase motor 3. The auxiliary device 4 is connected to the electric power supply circuits 11P and 11N via the auxiliary device drive circuits 12P and 12N and is driven by the first voltage (800 V) supplied from the battery 2.

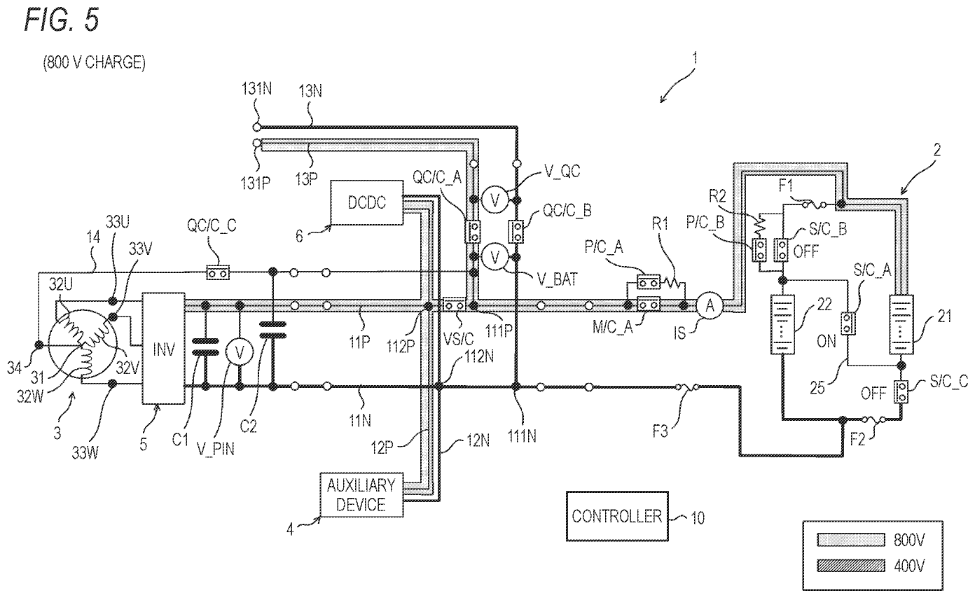

FIG. 5 is diagram showing a flow of a current when the electric vehicle including the power storage system 1 according to the first embodiment is charged at the first voltage (800 V charge).

When a charge plug is connected to the charge terminals 131P and 131N, the controller 10 performs CAN communication with charging equipment to recognize a charge voltage. When the charge voltage is the first voltage (800 V), the controller 10 turns on the second contactor S/C_A, turns off the third contactor S/C_B and the fourth contactor S/C_C, and connects the circuit in the battery 2 to the first voltage state (800 V), and at the same time, turns on the eighth contactor QC/C_A and the ninth contactor QC/C_B to charge the battery 2 with the first voltage (800 V). In this case, the controller 10 turns on the seventh contactor VS/C. Therefore, the auxiliary device 4 is connected to the DC power supply circuits 13P and 13N via the auxiliary device drive circuits 12P and 12N, and is driven by the first voltage (800 V) supplied from the charging equipment. Note that the controller 10 turns off the tenth contactor QC/C_C to cut off the electric power supply from the DC power supply circuits 13P and 13N to the three-phase motor 3.

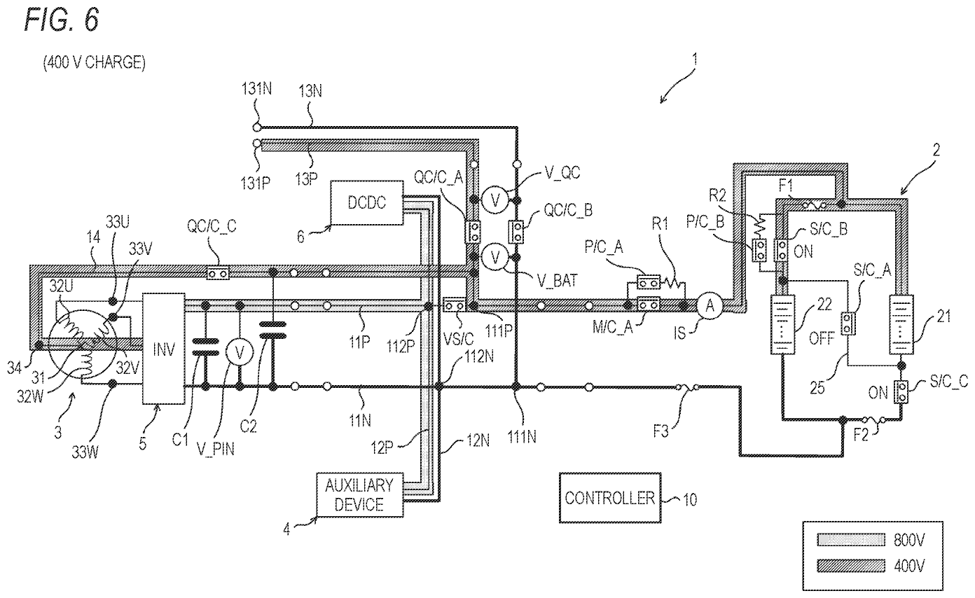

FIG. 6 is a diagram showing a flow of a current when the electric vehicle including the power storage system 1 according to the first embodiment is charged at the second voltage (400 V charge).

When a charge plug is connected to the charge terminals 131P and 131N, the controller 10 performs CAN communication with charging equipment to recognize a charge voltage. When the charge voltage is the second voltage (400 V), the controller 10 turns off the second contactor S/C_A, turns on the third contactor S/C_B and the fourth contactor S/C_C, and connects the circuit in the battery 2 to the second voltage state (400 V), and at the same time, turns on the eighth contactor QC/C_A and the ninth contactor QC/C_B to charge the battery 2 with the second voltage (400 V). In this case, the controller 10 turns off the seventh contactor VS/C and turns on the tenth contactor QC/C_C. In this way, the three-phase motor 3 and the inverter 5 connected to the DC power supply circuits 13P and 13N via the branch circuit 14 boost the second voltage (400 V) supplied from the charging equipment to the first voltage (800 V) to drive the auxiliary device 4.

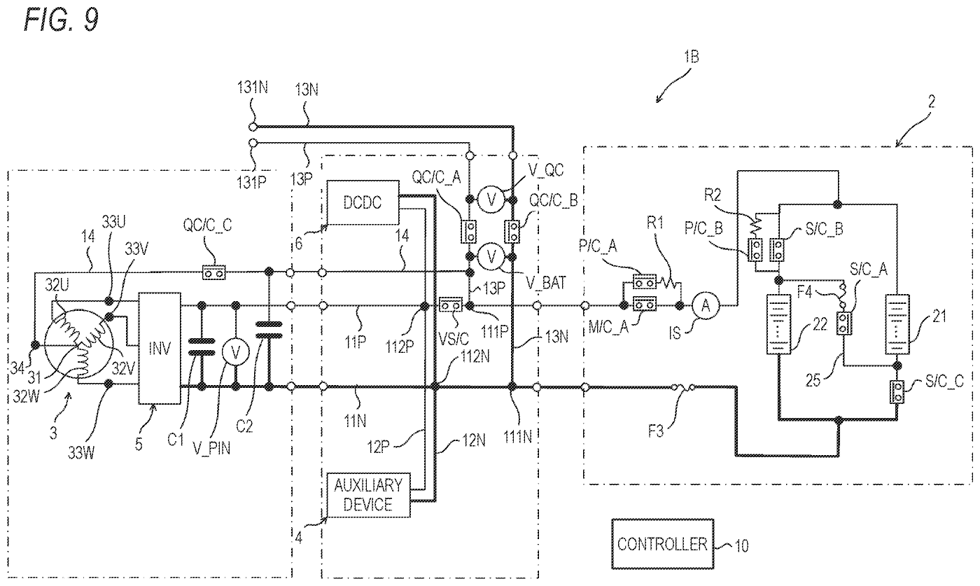

FIG. 9 is a diagram showing a configuration of a power storage system 1B according to a first modification.

As shown in FIG. 9, the power storage system 1B according to the first modification has the same basic configuration as the power storage system 1 according to the above-described embodiment, but has a difference from the power storage system 1 according to the above-described embodiment in that a fourth fuse F4 disposed in the connection circuit 25 is provided instead of the first fuse F1 and the second fuse F2 of the above-described embodiment. With the power storage system 1B according to the first modification, when an abnormality such as an impact due to a vehicle collision or a short circuit in the battery 2 occurs, the controller 10 can also prevent the occurrence of an electric shock during the abnormality by causing the third fuse F3 to perform cutoff and turning off (opening) the first contactor M/C_A. Since the contactors S/C_A, S/C_B, and S/C_C are arranged in each path of the battery 2, respectively, if these contactors S/C_A, S/C_B, and S/C_C are also turned off when an abnormality occurs, it is possible to reliably cut off a circuit in either the first voltage state or the second voltage state.

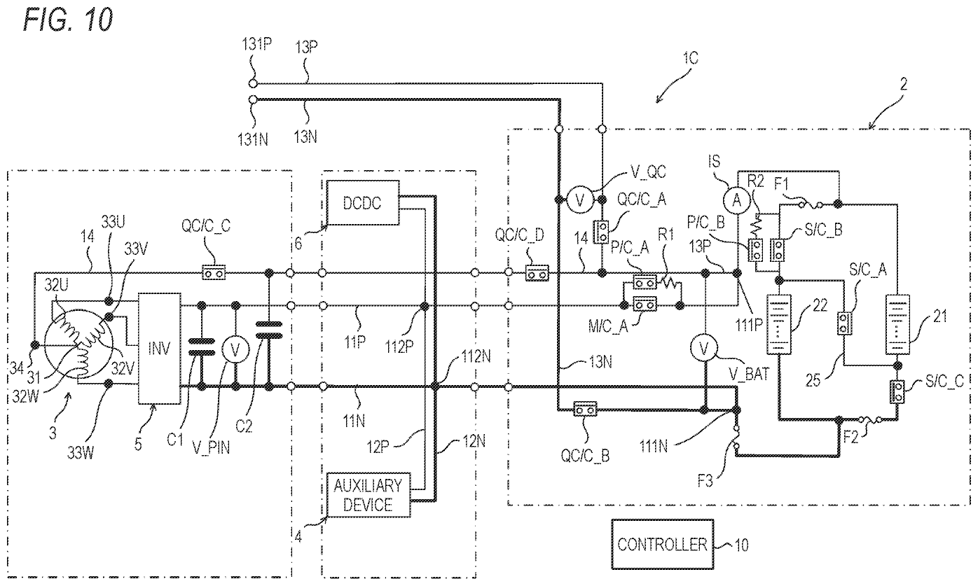

FIG. 10 is a diagram showing a configuration of a power storage system 1C according to a second modification.

In the power storage system 1 according to the above-described embodiment, the eighth contactor QC/C_A which is a main switch for charging is connected in series to the fourth contactor M/C_A which is the main switch of the battery 2. However, in the power storage system 1C according to the second modification, the eighth contactor QC/C_A is connected in parallel to the fourth contactor M/C_A as shown in FIG. 10.

In such a power storage system 1C according to the second modification, the same effect as those of the power storage system 1 according to the above-described embodiment can also be obtained. In the power storage system 1C according to the second modification, during charging with the second voltage (400 V), the battery 2 charged with the second voltage (400 V) can be separated, by the fourth contactor M/C_A, from the first voltage (800 V) boosted by the three-phase motor 3 and the inverter 5, and thus no switch component corresponding to the seventh contactor VS/C in the above-described embodiment is required.

In the power storage system 1C according to the second modification, it is assumed that the eighth contactor QC/C_A, the ninth contactor QC/C_B, the second voltage sensor V_BAT, and the third voltage sensor V_QC are disposed in the battery 2 and the branch circuit 14 is drawn out from inside the battery 2. Therefore, an eleventh contactor QC/C_D is provided in the battery 2 at a position closer to the inverter 5 than a position in the vicinity of a branch of the branch circuit 14 in order to cut off connection with the outside of the battery when an abnormality occurs.

With the power storage system 1C according to the second modification, when an abnormality such as an impact due to a vehicle collision or a short circuit in the battery 2 occurs, the controller 10 can also prevent the occurrence of an electric shock during the abnormality by causing the third fuse F3 to perform cutoff and turning off (opening) the first contactor M/C_A. Since the contactors S/C_A. S/C_B, and S/C_C are arranged in each path of the battery 2, respectively, if these contactors S/C_A, S/C_B, and S/C_C are also turned off when an abnormality occurs, it is possible to reliably cut off a circuit in either the first voltage state or the second voltage state.

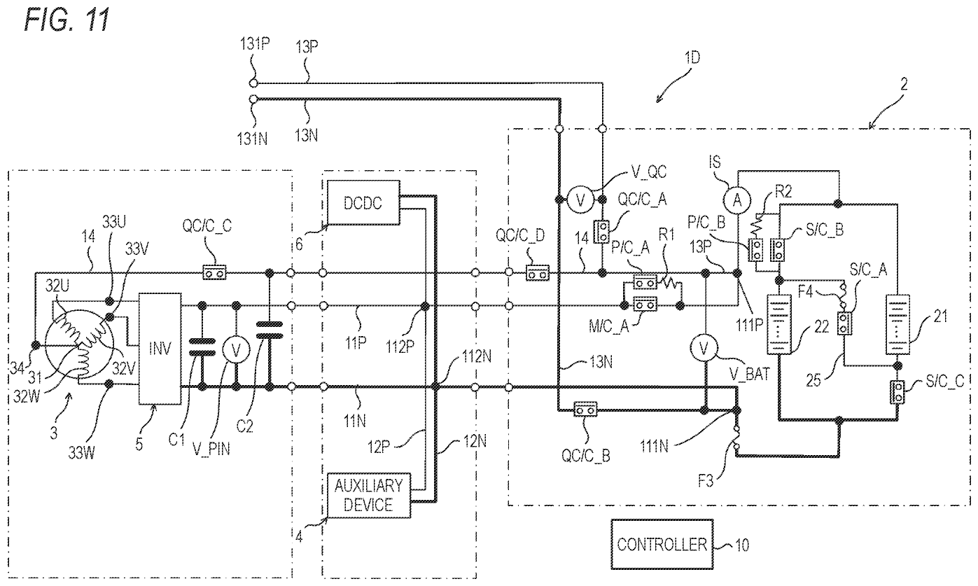

FIG. 11 is a diagram showing a configuration of a power storage system 1D according to a third modification.

As shown in FIG. 11, the power storage system 1D according to the third modification has the same basic configuration as the power storage system 1C according to the second modification, but has a difference from the power storage system 1C according to the second modification in that a fourth fuse F4 disposed in the connection circuit 25 is provided instead of the first fuse F1 and the second fuse F2 of the second modification. With the power storage system 1D according to the third modification, when an abnormality such as an impact due to a vehicle collision or a short circuit in the battery 2 occurs, the controller 10 can also prevent the occurrence of an electric shock during the abnormality by causing the third fuse F3 to perform cutoff and turning off (opening) the first contactor M/C_A. Since the contactors S/C_A, S/C_B, and S/C_C are arranged in each path of the battery 2, respectively, if these contactors S/C_A, S/C_B, and S/C_C are also turned off when an abnormality occurs, it is possible to reliably cut off a circuit in either the first voltage state or the second voltage state.

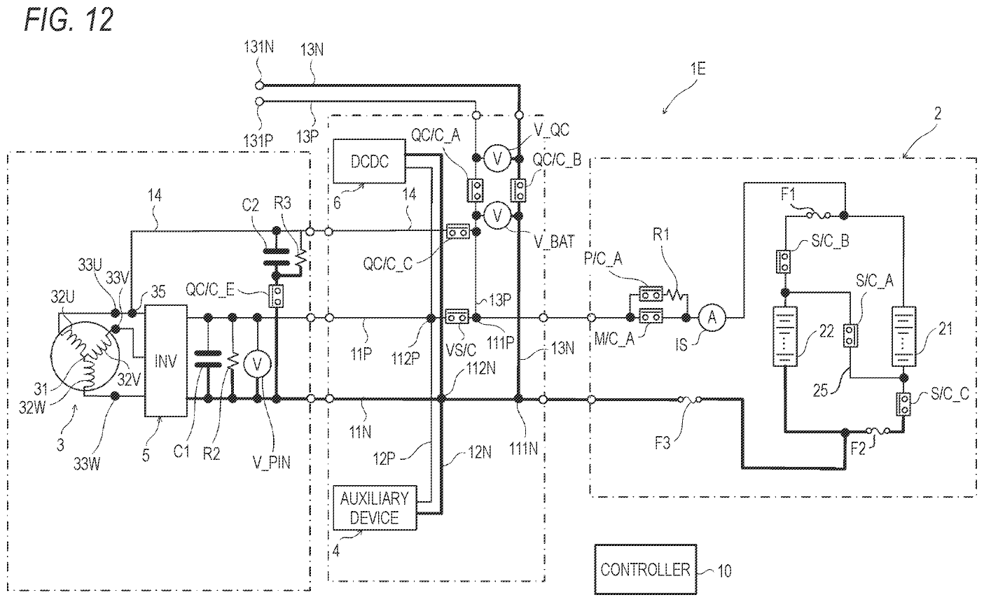

FIG. 12 is a diagram showing a configuration of a power storage system 1E according to a fourth modification.

As shown in FIG. 12, the power storage system 1E according to the fourth modification has the same basic configuration as the power storage system 1 according to the above-described embodiment. However, in the power storage system 1 of the above-described embodiment, the branch circuit 14 is connected to the neutral point 31, whereas in the fourth modification, the branch circuit 14 is connected to any one phase of the coils 32U, 32V, and 32W. In the present modification, the coil 32U among the coils 32U, 32V, and 32W of three phases is connected to the branch circuit 14 via a connection terminal 35 positioned between the U-phase terminal 33U and the inverter 5. In this way, when a DC current (400 V) is supplied from the branch circuit 14 to the connection terminal 35 during charging with the second voltage (400 V charge), by switching a plurality of switching elements, the inverter 5 can cause the three-phase motor 3 to function as a booster circuit that boosts the DC current (to 800 V) using the coils of two other phases (in the present embodiment, the coils 32V and 32W).

With the power storage system 1E according to the fourth modification, when an abnormality such as an impact due to a vehicle collision or a short circuit in the battery 2 occurs, the controller 10 can also prevent the occurrence of an electric shock during the abnormality by causing the third fuse F3 to perform cutoff and turning off (opening) the first contactor M/C_A. Since the contactors S/C_A, S/C_B, and S/C_C are arranged in each path of the battery 2, respectively, if these contactors S/C_A, S/C_B, and S/C_C are also turned off when an abnormality occurs, it is possible to reliably cut off a circuit in either the first voltage state or the second voltage state.

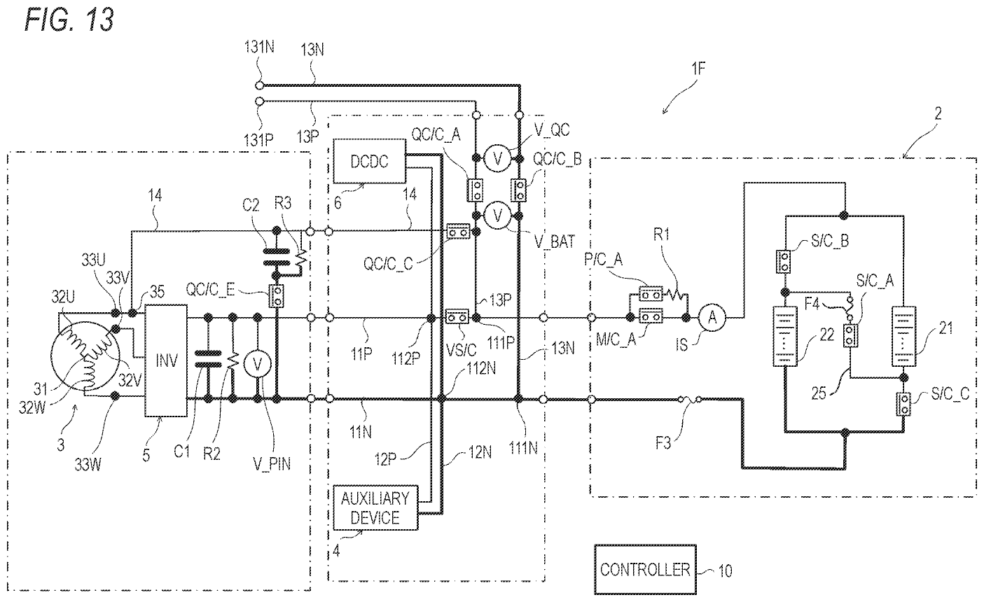

FIG. 13 is a diagram showing a configuration of a power storage system 1F according to a fifth modification.

As shown in FIG. 13, the power storage system 1F according to the fifth modification has the same basic configuration as the power storage system 1E according to the fourth modification, but has a difference from the power storage system 1E according to the fourth modification in that a fourth fuse F4 disposed in the connection circuit 25 is provided instead of the first fuse F1 and the second fuse F2 of the fourth modification. When an overcurrent occurs inside the battery 2 due to an internal short circuit or the like, electric connection inside the battery 2 is cut off by blowing the fourth fuse F4 to protect the battery 2. With the power storage system 1F according to the fifth modification, when an abnormality such as an impact due to a vehicle collision or a short circuit in the battery 2 occurs, the controller 10 can also prevent the occurrence of an electric shock during the abnormality by causing the third fuse F3 to perform cutoff and turning off (opening) the first contactor M/C_A. Since the contactors S/C_A, S/C_B, and S/C_C are arranged in each path of the battery 2, respectively, if these contactors S/C_A, S/C_B, and S/C_C are also turned off when an abnormality occurs, it is possible to reliably cut off a circuit in either the first voltage state or the second voltage state.

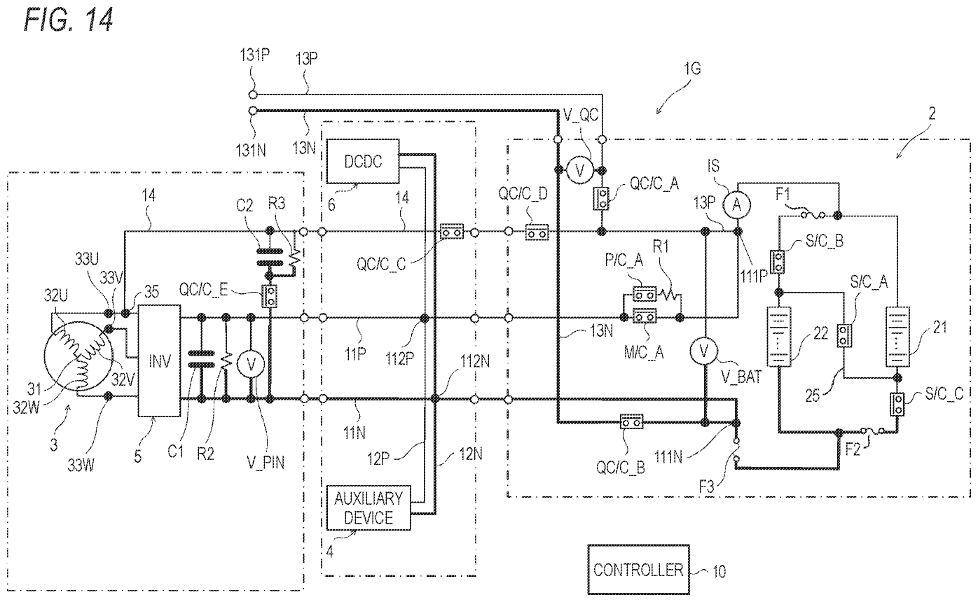

FIG. 14 is a diagram showing a configuration of a power storage system 1G according to a sixth modification.

In the power storage system 1E according to the fourth modification, the eighth contactor QC/C_A which is a main switch for charging is connected in series to the fourth contactor M/C_A which is the main switch of the battery 2. However, in the power storage system 1G according to the sixth modification, the eighth contactor QC/C_A is connected in parallel to the fourth contactor M/C_A as shown in FIG. 14.

In the power storage system 1G according to the sixth modification, the same effect as those of the power storage system 1E according to the fourth modification can be obtained. In the power storage system 1G according to the sixth modification, during charging with the second voltage (400 V), the battery 2 charged with the second voltage (400 V) can be separated, by the fourth contactor M/C_A, from the first voltage (800 V) boosted by the three-phase motor 3 and the inverter 5, and thus no switch component corresponding to the seventh contactor VS/C in the above-described embodiment is required.

In the power storage system 1G according to the sixth modification, it is assumed that the eighth contactor QC/C_A, the ninth contactor QC/C_B, the second voltage sensor V_BAT, and the third voltage sensor V_QC are disposed in the battery 2 and the branch circuit 14 is drawn out from inside the battery 2. Therefore, an eleventh contactor QC/C_D is provided in the battery 2 at a position closer to the inverter 5 than a position in the vicinity of the branch of the branch circuit 14 in order to cut off connection with the outside of the battery when an abnormality occurs.

With the power storage system 1G according to the sixth modification, when an abnormality such as an impact due to a vehicle collision or a short circuit in the battery 2 occurs, the controller 10 can also prevent the occurrence of an electric shock during the abnormality by causing the third fuse F3 to perform cutoff and turning off (opening) the first contactor M/C_A. Since the contactors S/C_A, S/C_B, and S/C_C are arranged in each path of the battery 2, respectively, if these contactors S/C_A, S/C_B, and S/C_C are also turned off when an abnormality occurs, it is possible to reliably cut off a circuit in either the first voltage state or the second voltage state.

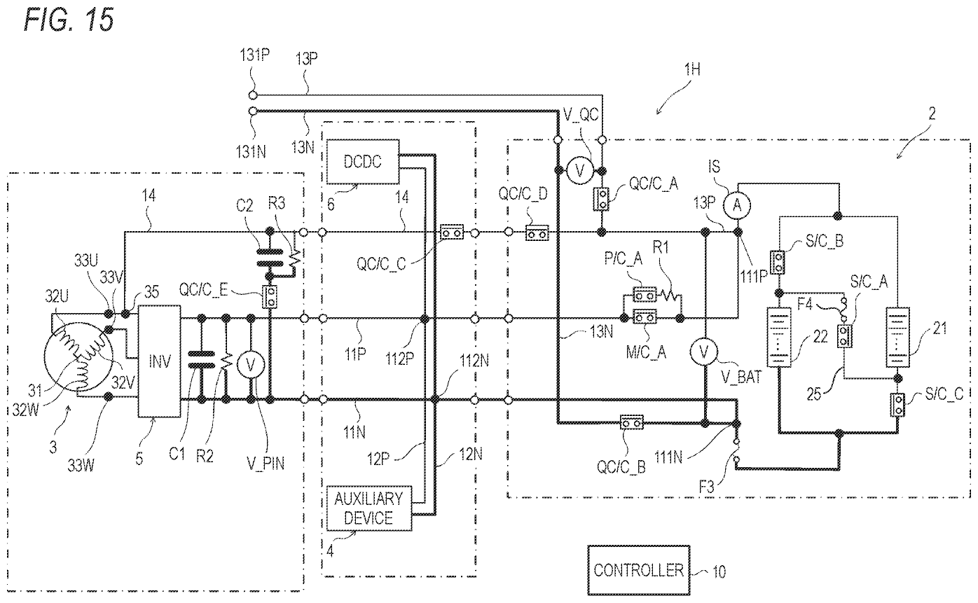

FIG. 15 is a diagram showing a configuration of a power storage system 1H according to a seventh modification.

As shown in FIG. 15, the power storage system 1H according to the seventh modification has the same basic configuration as the power storage system 1G according to the sixth modification, but has a difference from the power storage system 1G according to the sixth modification in that a fourth fuse F4 disposed in the connection circuit 25 is provided instead of the first fuse F1 and the second fuse F2 of the sixth modification. With the power storage system 1H according to the seventh modification, when an abnormality such as an impact due to a vehicle collision or a short circuit in the battery 2 occurs, the controller 10 can also prevent the occurrence of an electric shock during the abnormality by causing the third fuse F3 to perform cutoff and turning off (opening) the first contactor M/C_A. Since the contactors S/C_A. S/C_B, and S/C_C are arranged in each path of the battery 2, respectively, if these contactors S/C_A, S/C_B, and S/C_C are also turned off when an abnormality occurs, it is possible to reliably cut off a circuit in either the first voltage state or the second voltage state.

Although various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiment may be freely combined without departing from the gist of the invention.

For example, in the above embodiment, the controller 10 performs CAN communication with the charging equipment, but the communication method is not limited to CAN communication, and any communication method can be adopted.

In the present description, at least the following matters are described. Although corresponding constituent elements or the like in the above-described embodiments are shown in parentheses, the present invention is not limited thereto.
(1) A battery, including:
a first power storage (first power storage 21);
a second power storage (second power storage 22);
a positive node (positive node 23) configured to connect in parallel a positive terminal of the first power storage and a positive terminal of the second power storage;
a negative node (negative node 24) configured to connect in parallel a negative terminal of the first power storage and a negative terminal of the second power storage;
one of a main contactor (first contactor M/C_A) and a control cutoff fuse (third fuse F3) configured to cut off according to a control signal, the one being at a side opposite to the first power storage and the second power storage with respect to the positive node;
an other one of the main contactor and the control cutoff fuse, the other one being provided at a side opposite to the first power storage and the second power storage with respect to the negative node;
a connection circuit (connection circuit 25) configured to connect the negative terminal of the first power storage and the positive terminal of the second power storage;
a first switching contactor (second contactor S/C_A) provided in the connection circuit;
a second switching contactor (third contactor S/C_B) provided between the positive node and a first connection portion (first connection portion 26) configured to connect the positive terminal of the second power storage and the connection circuit;
a third switching contactor (fourth contactor S/C_C) provided between the negative node and a second connection portion (second connection portion 27) configured to connect the negative terminal of the first power storage and the connection circuit; and
a controller (controller 10) configured to control on and off of the main contactor and the first to third switching contactors,
in which the controller is configured to switch between
   a first voltage state in which the first switching contactor is in an on state, the second switching contactor and the third switching contactor are in an off state, and the first power storage and the second power storage are connected in series and chargeable at a first voltage, and
   a second voltage state in which the first switching contactor is in an off state, the second switching contactor and the third switching contactor are in an on state, and the first power storage and the second power storage are connected in parallel and chargeable at a second voltage.
According to (1), the main contactor and the control cutoff fuse are provided at the positive end portion and the negative end portion of the first power storage and the second power storage, and the switching contactor is provided for each path. Therefore, the battery can be disconnected from other electric devices regardless of whether the battery is in the first voltage state or the second voltage state, and the occurrence of an electric shock can be prevented.
(2) The battery according to (1), in which the controller controls the battery to be in either the first voltage state or the second voltage state, in a case where an auxiliary contactor signal is ON.
According to (2), a selector switch can be treated as an auxiliary contactor.
(3) The battery according to (1),
in which the controller turns off the main contactor and cuts off the control cutoff fuse based on occurrence of an impact.
According to (3), w % ben the battery is mounted on a vehicle, by turning off the main contactor and cutting off the control cutoff fuse during a collision, the battery can be separated from other electric devices, and the occurrence of an electric shock can be prevented.
(4) The battery according to (1),
in which the controller turns off the main contactor and cuts off the control cutoff fuse based on occurrence of a short circuit.
According to (4), by turning off the main contactor and cutting off the control cutoff fuse when a short circuit occurs, the battery can be separated from other electric devices, and the occurrence of an electric shock can be prevented.
(5) The battery according to (1),
in which the second switching contactor and a first fuse (first fuse F1) are connected in series between the first connection portion and the positive node, and
the third switching contactor and a second fuse (second fuse F2) are connected in series between the second connection portion and the negative node.
According to (5), the battery can be protected from an overcurrent during an internal short circuit.
(6) The battery according to (1),
in which the first switching contactor and a fuse (fourth fuse) are connected in series in the connection circuit.
According to (6), the battery can be protected from an overcurrent during an internal short circuit.
(7) A power storage system, including:
the battery according to any one of (1) to (6);
a three-phase motor (three-phase motor 3) in which coils of three phases (coils 32U, 32V, 32W) are connected at a neutral point (neutral point 31), the three-phase motor being driven by electric power supplied from the battery;
an inverter (inverter 5) connected on an electric power transmission path between the battery and the three-phase motor; and
a DC power supply circuit (DC power supply circuits 13P, 13N) connected to a connection portion (connection portions 111P, 111N) positioned on an electric power transmission path between the inverter and the battery.
in which the DC power supply circuit has a branch circuit (branch circuit 14) connected to the neutral point at a positive electrode side of the DC power supply circuit.
According to (7), since the DC power supply circuit has the branch circuit connected to the neutral point of the three-phase motor at the positive electrode side thereof connected to the connection portion positioned on the electric power transmission path between the inverter and the battery, voltage conversion can be performed using the three-phase motor and the inverter. Accordingly, even in a case where the voltage state of the charging equipment is different from an operating voltage of an auxiliary device or the like, it is possible to eliminate a dedicated voltage converter, and thus a manufacturing cost can be reduced.
(8) The power storage system according to (7), further including:
an auxiliary device (auxiliary device 4) configured to be driven by DC electric power from the battery and an external power supply; and
an auxiliary device drive circuit (auxiliary device drive circuits 12P, 12N) connected on an electric power transmission path between the inverter and the connection portion, and configured to supply electric power to the auxiliary device,
in which the auxiliary device is operated at the first voltage.
According to (8), it is unnecessary to perform voltage conversion during traveling and during charging at the first voltage.
(9) The power storage system according to (8),
in which when the battery is charged at the second voltage, the controller causes the inverter to boost a voltage supplied from the branch circuit to the three-phase motor to the first voltage.
According to (9), since voltage conversion can be performed using the three-phase motor and the inverter, it is possible to eliminate an auxiliary device voltage converter.
(10) A power storage system, including:
the battery according to any one of (1) to (6);
a three-phase motor (three-phase motor 3) in which coils of three phases (coils 32U, 32V, 32W) are connected at a neutral point (neutral point 31), the three-phase motor being driven by electric power supplied from the battery;
an inverter (inverter 5) connected on an electric power transmission path (electric power supply circuits 11P, 11N) between the battery and the three-phase motor; and
a DC power supply circuit (DC power supply circuits 13P, 13N) connected to a connection portion (connection portion 111P, 111N) positioned on an electric power transmission path between the inverter and the battery,
in which the DC power supply circuit has a branch circuit (branch circuit 14) connected to a coil of one phase (coil 32U) among the coils of three phases at a positive electrode side of the DC power supply circuit.
According to (10), since the DC power supply circuit has the branch circuit connected to a coil of one phase at the positive electrode side thereof connected to the connection portion positioned on the electric power transmission path between the inverter and the battery, voltage conversion can be performed using the three-phase motor and the inverter. Accordingly, even in a case where the voltage state of the charging equipment is different from an operating voltage of an auxiliary device or the like, it is possible to eliminate a dedicated voltage converter, and thus a manufacturing cost can be reduced.
(11) The power storage system according to (10), further including:
an auxiliary device (auxiliary device 4) configured to be driven by DC electric power from the battery and an external power supply; and
an auxiliary device drive circuit (auxiliary device drive circuits 12P, 12N) connected on an electric power transmission path between the inverter and the connection portion, and configured to supply electric power to the auxiliary device,
in which the auxiliary device is operated at the first voltage.
According to (11), it is unnecessary to perform voltage conversion during traveling and during charging at the first voltage.
(12) The power storage system according to (11),
in which when the battery is charged at the second voltage, the controller causes the inverter to boost a voltage supplied from the branch circuit to the three-phase motor to the first voltage.
According to (12), since voltage conversion can be performed using the three-phase motor and the inverter, it is possible to eliminate an auxiliary device voltage converter.

What is claimed is:

1. A battery, comprising:
a first power storage;
a second power storage;
a positive node configured to connect in parallel a positive terminal of the first power storage and a positive terminal of the second power storage;
a negative node configured to connect in parallel a negative terminal of the first power storage and a negative terminal of the second power storage;
one of a main contactor and a control cutoff fuse configured to cut off according to a control signal, the one being provided at a side opposite to the first power storage and the second power storage with respect to the positive node;
an other one of the main contactor and the control cutoff fuse, the other one being provided at a side opposite to the first power storage and the second power storage with respect to the negative node;
a connection circuit configured to connect the negative terminal of the first power storage and the positive terminal of the second power storage;
a first switching contactor provided in the connection circuit;
a second switching contactor provided between the positive node and a first connection portion configured to connect the positive terminal of the second power storage and the connection circuit;
a third switching contactor provided between the negative node and a second connection portion configured to connect the negative terminal of the first power storage and the connection circuit; and
a controller configured to control on and off of the main contactor and the first to third switching contactors,
wherein the controller is configured to switch between
a first voltage state in which the first switching contactor is in an on state, the second switching contactor and the third switching contactor are in an off state, and the first power storage and the second power storage are connected in series and chargeable at a first voltage, and
a second voltage state in which the first switching contactor is in an off state, the second switching contactor and the third switching contactor are in an on state, and the first power storage and the second power storage are connected in parallel and chargeable at a second voltage.

2. The battery according to claim 1,
wherein the controller controls the battery to be in either the first voltage state or the second voltage state, in a case where an auxiliary contactor signal is ON.

3. The battery according to claim 1,
wherein the controller turns off the main contactor and cuts off the control cutoff fuse based on occurrence of an impact.

4. The battery according to claim 1,
wherein the controller turns off the main contactor and cuts off the control cutoff fuse based on occurrence of a short circuit.

5. The battery according to claim 1,
wherein the second switching contactor and a first fuse are connected in series between the first connection portion and the positive node, and
the third switching contactor and a second fuse are connected in series between the second connection portion and the negative node.

6. The battery according to claim 1,
wherein the first switching contactor and a fuse are connected in series in the connection circuit.

7. A power storage system, comprising:
the battery according to claim 1;
a three-phase motor in which coils of three phases are connected at a neutral point, the three-phase motor being driven by electric power supplied from the battery;
an inverter connected on an electric power transmission path between the battery and the three-phase motor; and
a DC power supply circuit connected to a connection portion positioned on an electric power transmission path between the inverter and the battery,
wherein the DC power supply circuit has a branch circuit connected to the neutral point at a positive electrode side of the DC power supply circuit.

8. The power storage system according to claim 7, further comprising:
an auxiliary device configured to be driven by DC electric power from the battery and an external power supply; and
an auxiliary device drive circuit connected on an electric power transmission path between the inverter and the connection portion, and configured to supply electric power to the auxiliary device,
wherein the auxiliary device is operated at the first voltage.

9. The power storage system according to claim 8,
wherein when the battery is charged at the second voltage, the controller causes the inverter to boost a voltage supplied from the branch circuit to the three-phase motor to the first voltage.

10. A power storage system, comprising:
the battery according to claim 1;
a three-phase motor in which coils of three phases are connected at a neutral point, the three-phase motor being driven by electric power supplied from the battery;
an inverter connected on an electric power transmission path between the battery and the three-phase motor; and
a DC power supply circuit connected to a connection portion positioned on an electric power transmission path between the inverter and the battery,
wherein the DC power supply circuit has a branch circuit connected to a coil of one phase among the coils of three phases at a positive electrode side of the DC power supply circuit.

11. The power storage system according to claim 10, further comprising:
an auxiliary device configured to be driven by DC electric power from the battery and an external power supply; and
an auxiliary device drive circuit connected on an electric power transmission path between the inverter and the connection portion, and configured to supply electric power to the auxiliary device,
wherein the auxiliary device is operated at the first voltage.

12. The power storage system according to claim 11,
wherein when the battery is charged at the second voltage, the controller causes the inverter to boost a voltage supplied from the branch circuit to the three-phase motor to the first voltage.
